(19) United States
(12) Patent Application Publication
(10) Pub. No.: US 2023/0351441 A1
(43) Pub. Date: Nov. 2, 2023

(54) Apparatus And Method For Classifying Fraudulent Advertising Users

(71) Applicant: Netmarble Corporation, Seoul (KR)

(72) Inventors: Daehwan BANG, Seoul (KR); Jonghun MOON, Seoul (KR); Junho SON, Seoul (KR)

(21) Appl. No.: 18/119,086

(22) Filed: Mar. 8, 2023

(30) Foreign Application Priority Data
Apr. 28, 2022 (KR) 10-2022-0052868

(51) Int. Cl. G06Q 30/0241

(52) U.S. Cl. CPC G06Q 30/0248

(57) ABSTRACT

An apparatus and method for classifying fraudulent advertising users are disclosed. The apparatus includes a processor and a memory storing instructions executable by the processor, in which, when the instructions are executed by the processor, the processor receives user data of users who are first determined to be fraudulent advertising users in relation to advertising fraud of an online advertisement; extracts advertising fraud-related features from the user data; classifies fake users from the users through clustering of the users based on the extracted features; searches for a fraud score of each of remaining users who are not classified as the fake users among the users, using an Internet protocol (IP)-based fraud search service server; and classifies the remaining users into the fake users and genuine users based on the fraud score.

### CROSS-REFERENCE TO RELATED APPLICATIONS

This application claims priority under 35 U.S.C. § 119 to Korean Patent Application No. 10-2022-0052868 filed on Apr. 28, 2022, in the Korean Intellectual Property Office. The entire contents of which are incorporated herein by reference in their entirety.

### FIELD

At least one example embodiment relates to a technology for classifying fraudulent advertising users.

### BACKGROUND

An advertiser that provides content (e.g., applications) may advertise their content to general users via electronic media. A manager of the electronic media may be a publisher and, as new users are introduced to the content through an advertisement, may charge an advertising fee to the advertiser in return for this. Advertising fraud may refer to an act that deliberately and fraudulently generates traffic and charges an advertising fee therefor.

### SUMMARY

This section provides a general summary of the disclosure, and is not a comprehensive disclosure of its full scope or all of its features.

At least one example embodiment relates to an apparatus for classifying fraudulent advertising users.

In at least one example embodiment, the apparatus may include a processor; and a memory configured to store instructions to be executed by the processor. When the instructions are executed by the processor, the processor may receive user data of users who are first determined to be fraudulent advertising users in relation to advertising fraud of an online advertisement; extract advertising fraud-related features from the user data; classify fake users from the users through clustering of the users based on the extracted features; search for a fraud score for each of remaining users who are not classified as the fake users among the users using an Internet protocol (IP)-based fraud search service server; and classify the remaining users into the fake users and genuine users based on the fraud score.

In at least one example embodiment, the processor may classify, as the fake users, users having the fraud score that is greater than or equal to a set threshold value; and determine, as the genuine users, users having the fraud score that is less than the set threshold value.

In at least one example embodiment, the processor may normalize the extracted features.

In at least one example embodiment, the processor may reduce a dimensionality of the normalized features.

In at least one example embodiment, the processor may perform clustering on the users based on features with the reduced dimensionality.

In at least one example embodiment, the features may include a feature relating to an installation time of the content that is the target of the online advertisement, a feature relating to a login time for the content, a feature relating to a ratio of users who charge a fee within a set time after an installation of the content, a feature relating to a ratio between a total amount charged for the content and the number of logged in users, a feature relating to a ratio between the total amount charged for the content and the number of users who charge a fee, a feature relating to a ratio of users logged in next day after the installation of the content, and a feature relating to a ratio of users opening the content after the installation of the content.

In at least one example embodiment, the processor may perform grouping on the user data of the users based on the installation date and time of the content; generate time series data on the number of installations of the content per date and time based on grouped user data obtained through the grouping; extract a periodic vector for each group of the grouped user data by performing time series decomposition on the time series data; calculate a correlation coefficient between the periodic vector for each group and a valid periodic vector for user data of a valid group that is a group of general users; and convert the calculated correlation coefficient to a scalar value.

In at least one example embodiment, the processor may perform grouping on the user data of the users based on the login date and time of the content; generate time series data on the number of logins per date and time based on grouped user data obtained through the grouping; extract a periodic vector for each group of the grouped user data by performing time series decomposition on the time series data; calculate a correlation coefficient between the periodic vector for each group and a valid periodic vector for user data of a valid group that is a group of general users; and convert the calculated correlation coefficient to a scalar value.

At least one example embodiment relates to a method of classifying fraudulent advertising users.

In at least one example embodiment, the method may include: receiving user data of users who are first determined to be fraudulent advertising users in relation to advertising fraud of an online advertisement; extracting advertising fraud-related features from the user data; classifying fake users from the users through clustering of the users based on the extracted features; searching for a fraud score for each of remaining users who are not classified as the fake users among the users using an IP-based fraud search service server; and classifying the remaining users into the fake users and genuine users based on the fraud score.

In at least one example embodiment, the classifying into the fake users and the genuine users may include: classifying, as the fake users, users having the fraud score that is greater than or equal to a set threshold value; and determining, as the genuine users, users having the fraud score that is less than the set threshold value.

In at least one example embodiment, the classifying the fake users from the users may include normalizing the extracted features.

In at least one example embodiment, the classifying the fake users from the users may further include reducing a dimensionality of the normalized features.

In at least one example embodiment, the classifying the fake users from the users may further include performing clustering on the users based on features with the reduced dimensionality.

In at least one example embodiment, the features may include a feature relating to an installation time of the content that is the target of the online advertisement, a feature relating to a login time for the content, a feature relating to a ratio of users who charge a fee within a set time after an installation of the content, a feature relating to a ratio between a total amount charged for the content and the number of logged in users, a feature relating to a ratio between the total amount charged for the content and the number of users who charge a fee, a feature relating to a ratio of users logged in next day after the installation of the content, and a feature relating to a ratio of users opening the content after the installation of the content.

In at least one example embodiment, the extracting the features may include: performing grouping on the user data of the users based on the installation date and time of the content; generating time series data on the number of installations of the content per date and time based on grouped user data obtained through the grouping; extracting a periodic vector for each group of the grouped user data by performing time series decomposition on the time series data; calculating a correlation coefficient between the periodic vector for each group and a valid periodic vector for user data of a valid group that is a group of general users; and converting the calculated correlation coefficient to a scalar value.

In at least one example embodiment, the extracting the features may include: performing grouping on the user data of the users based on the login date and time of the content; generating time series data on the number of logins per date and time based on grouped user data obtained through the grouping; extracting a periodic vector for each group of the grouped user data by performing time series decomposition on the time series data; calculating a correlation coefficient between the periodic vector for each group and a valid periodic vector for user data of a valid group that is a group of general users; and converting the calculated correlation coefficient to a scalar value.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 is a diagram illustrating types of advertising fraud;

FIG. 2 is a flowchart illustrating an example of a method of classifying fraudulent advertising users according to at least one example embodiment;

FIG. 3 is a diagram illustrating an example of user data clustered by an apparatus for classifying fraudulent advertising users according to at least one example embodiment;

FIG. 4 is a flowchart illustrating an example of a method of extracting a content installation time-related correlation coefficient between users from user data according to at least one example embodiment;

FIG. 5 is a flowchart illustrating an example of a method of extracting a login time-related correlation coefficient between users from user data according to at least one example embodiment; and

FIG. 6 is a block diagram illustrating an example of an apparatus for classifying fraudulent advertising users according to at least one example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected,” “coupled,” or “joined” to another component, a third component may be “connected,” “coupled,” and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted in the figures may occur out of the order. For example, two figures shown in succession may in fact be executed substantially concurrently or may sometimes be executed in the reverse order, depending upon the functionality/acts involved.

Unless otherwise defined, all terms, including technical and scientific terms, used herein have the same meaning as commonly understood by one of ordinary skill in the art to which the disclosure of this application pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings, and like reference numerals in the drawings refer to like elements throughout.

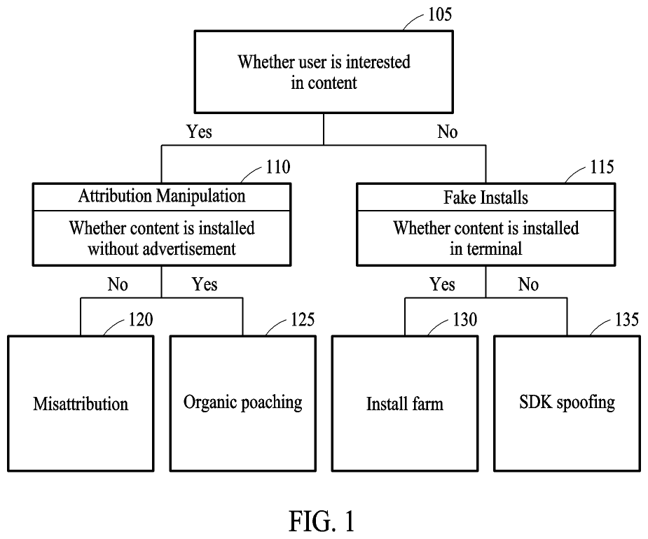

FIG. 1 is a diagram illustrating types of advertising fraud.

An advertiser providing content (e.g., an application) may advertise the content to general users through an electronic medium (hereinafter simply referred to as “medium”). A manager of the medium may be a publisher. New users may be introduced to content through advertisements and, in return for this, publishers may charge advertisers advertising fees for the advertisements. For example, an online advertisement for content A may be displayed on a user terminal of a user. In this example, when the user selects or clicks this advertisement, the user may be moved to a page from which they are able to download the content A. When the content A is installed in a normal way in the user terminal, a publisher of a medium may charge an advertiser of the content A an advertising fee in return for the installation. Advertising fraud in online advertisements refers to an act of a publisher charging advertising fees by generating traffic unfairly and fraudulently.

Referring to FIG. 1, illustrated is a criterion for classifying fraudulent advertising users according to a type of advertisement fraud. The fraudulent advertising users may be classified into a genuine user who desires to really use content and a fake user who is generated using an automatic program and does not exist, based on whether they are interested in content that is a target of an online advertisement, as indicated in reference numeral 105.

A publisher may search for an online advertisement to use content and manipulate records of genuine users who installed the content, which is referred to as attribution manipulation 110. For example, the publisher may manipulate the records as if the records show that users who installed the content by clicking the advertisement through another medium install the content by clicking the advertisement through their medium, which corresponds to misattribution 120. For example, the publisher may manipulate the records as if the records show that organic users who installed the content without the advertisement install the content by clicking the advertisement through their medium, which corresponds to organic poaching 125.

Alternatively, the publisher may use fake users who do not exist to click the online advertisement and install the content through the online advertisement for the purpose of increasing their advertising achievements, not for the purpose of really using the content, which corresponds to fake install 115. For example, the publisher may search for the online advertisement without really using the content and generate traffic to the online advertisement using fake users of terminals installing the content, which corresponds to install farm 130. For example, the publisher may generate fake users who do not exist but is present on the records by manipulating advertising achievement measurement records, which correspond to software development kit (SDK) spoofing 135.

Such fake users among the fraudulent advertising users may be considered for calculating indices and may thereby contaminate the indices, although they do not exist, when advertisers form statistics on their online advertisements. According to at least one example embodiment, an apparatus and method for classifying fraudulent advertising users may classify fraudulent advertising users into genuine users and fake users and may thereby reduce such contamination of the calculation of indices.

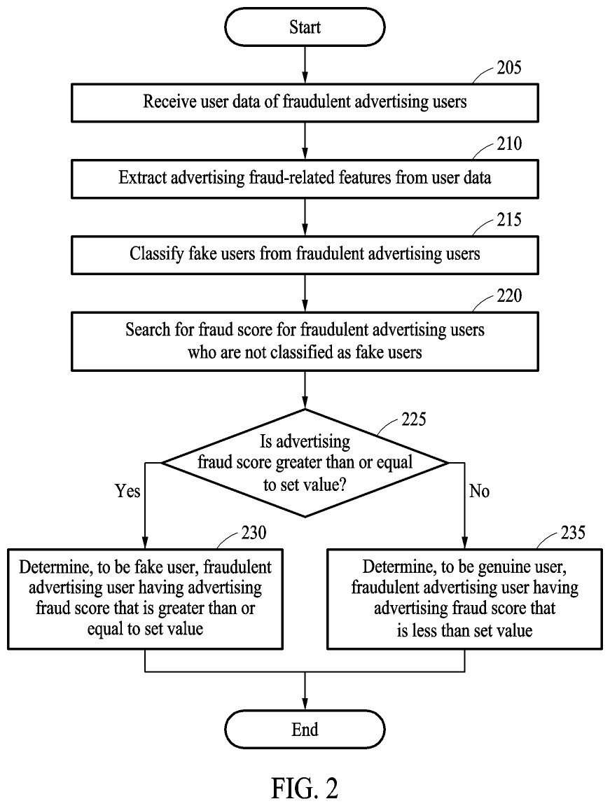

FIG. 2 is a flowchart illustrating an example of a method of classifying fraudulent advertising users according to at least one example embodiment.

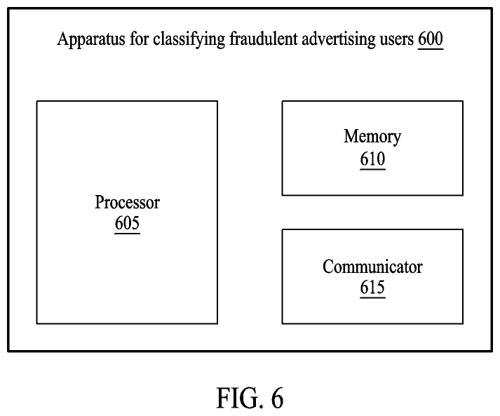

According to at least one example embodiment, in operation 205, an apparatus for classifying fraudulent advertising users (hereinafter simply referred to as “apparatus”) (e.g., an apparatus 600 for classifying fraudulent advertising users in FIG. 6) may receive user data of fraudulent advertising users.

In operation 210, the apparatus may extract advertising fraud-related features from the user data.

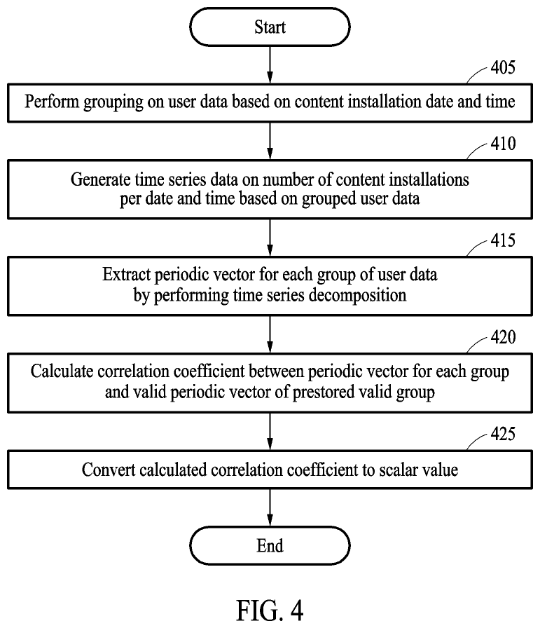

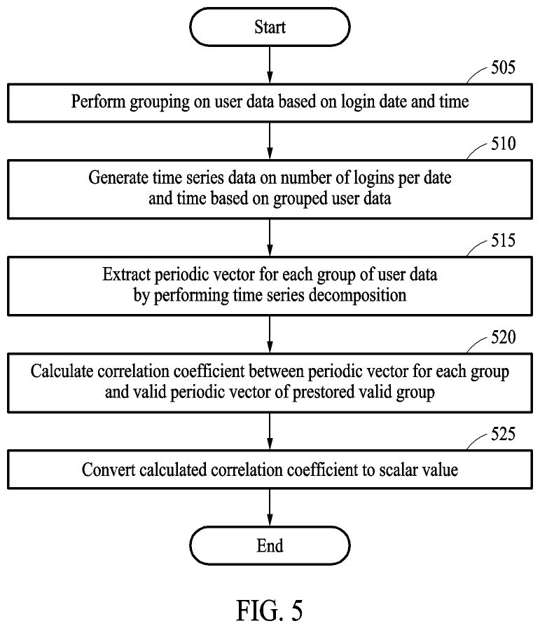

The advertising fraud-related features may include, for example, at least one of a feature relating to an installation time of content that is a target of an online advertisement, a feature relating to a login time for the content, a feature relating to a ratio of users who charge a fee within a set time after an installation of the content, a feature relating to a ratio between a total amount charged for the content and the number of logged in users, a feature relating to a ratio between the total amount charged for the content and the number of users who charge a fee, a feature relating to a ratio of users logged in next day after the installation of the content, or a feature relating to a ratio of users opening the content after the installation of the content. The feature relating to the installation time of the content and the feature relating to the login time for the content will be described in detail below with reference to FIGS. 4 and 5.

In operation 215, the apparatus may classify fake users from the fraudulent advertising users of operation 205 through clustering of the users based on the extracted features.

The apparatus may preprocess the extracted features for the clustering of the users. In at least one example embodiment, the preprocessing to be performed on the extracted features may include normalization and dimensionality reduction.

The apparatus may normalize the extracted features to evenly adjust the influence of the features extracted in operation 210 on the clustering. For example, the apparatus may perform min-max scaling on the extracted features.

The apparatus may reduce the dimensionality of the normalized features. For example, the apparatus may reduce the dimensionality of the normalized features by applying techniques such as a principal component analysis (PCA), t-distributed stochastic neighbor embedding (t-SNE), and an autoencoder. In addition to the foregoing example techniques, various techniques may be applied to reduce the dimensionality of the normalized features.

The apparatus may perform the clustering on the users using reduced features with the reduced dimensionality. For example, the apparatus may perform the clustering on the users by applying, to the reduced features, techniques such as a K-means algorithm, density-based spatial clustering of applications with noise (DBSCAN), and hierarchical DBSCAN (HDBSCAN). In addition to the foregoing example techniques, various techniques may be applied to the features for the clustering of the users.

The apparatus may classify the fake users based on a result of the clustering.

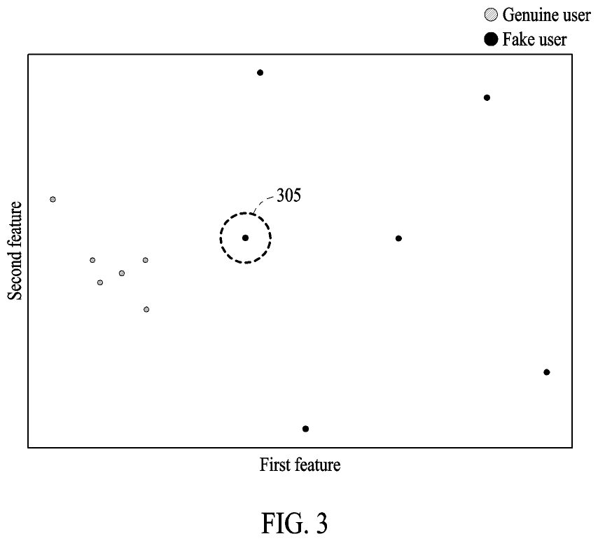

Although the fake users are classified from the fraudulent advertising users in operation 215, not all fake users may be classified in a reliable way. For example, FIG. 3 illustrates a visual example of clustering of users using features reduced into two dimensions through operations 210 and 215 performed on example user data including both genuine users and fake users.

In FIG. 3, although most fake users may be well classified from genuine users, for some fake users 305, identifying whether they are genuine users or fake users may not be easy. For example, the fake users 305 may be fake users introduced through a blacklisted Internet protocol (IP).

Referring back to FIG. 2, in operation 220, the apparatus may search for a fraud score for each of remaining users who are not classified as fake users among the users of operation 205, using an IP-based fraud search service (e.g., Scamalytics) server. The apparatus may search for the fraud score to classify the remaining users into fake users and genuine users.

For example, in operation 225, the apparatus may determine whether the advertising fraud score of a user is greater than or equal to a set value. When the advertising fraud score of the user is greater than or equal to the set value, the apparatus may determine the user to be a fake user in operation 230. When the advertising fraud score of the user is less than the set value, the apparatus may determine the user to be a genuine user in operation 235.

Hereinafter, a content installation time-related feature that is extracted in operation 210 will be described in detail below with reference to FIG. 4.

In at least one example embodiment, operation 210 may include operations 405, 410, 415, and 420. The apparatus may extract, from user data, a content installation time-related correlation coefficient between users as a content installation time-related feature. In operation 405, to extract the content installation time-related correlation coefficient, the apparatus may perform grouping on the user data based on a content installation date and time.

In operation 410, the apparatus may generate time series data on the number of content installations per date and time, based on user data grouped based on the content installation date and time.

In operation 415, the apparatus may extract a periodic vector for each group of the grouped user data by performing time series decomposition on the time series data.

The apparatus may generate time series data on the number of installations per date and time from user data of a valid group that is a group of general users who are not fraudulent advertising users, and extract a valid periodic vector from the generated time series data. The user data of the valid group may be data previously stored in the apparatus according to at least one example embodiment.

In operation 420, the apparatus may calculate a correlation coefficient between the periodic vector for each group and the valid periodic vector. In operation 425, the apparatus may substitute the calculated correlation coefficient with a scalar value to obtain the installation time-related feature.

Hereinafter, a login time-related feature extracted in operation 210 will be described with reference to FIG. 5.

The apparatus may extract, from user data, a login time-related correlation coefficient between users as a content login time-related feature. In operation 505, to extract the login time-related correlation coefficient, the apparatus may perform grouping on the user data based on the login date and time.

In operation 510, the apparatus may generate time series data on the number of logins per date and time based on user data grouped based on the login date and time. In operation 515, the apparatus may extract a periodic vector for each group of the grouped user data by performing time series decomposition on the time series data.

The apparatus may generate time series data on the number of logins per date and time from user data of a valid group and extract a valid periodic vector from the generated time series data.

In operation 520, the apparatus may calculate a correlation coefficient between the periodic vector for each group and the valid periodic vector. In operation 525, the apparatus may substitute the calculated correlation coefficient with a scalar value to obtain the login time-related feature.

FIG. 6 is a block diagram illustrating an example of an apparatus for classifying fraudulent advertising users according to at least one example embodiment.

Referring to FIG. 6, an apparatus 600 according to at least one example embodiment may include a processor 605, a memory 610 configured to store therein instructions to be executed by the processor 605, and a communicator 615 configured to communicate with a fraud search service server.

In at least one example embodiment, the processor 605 may receive user data of fraudulent advertising users. The processor 605 may extract advertising fraud-related features from the user data.

The advertising fraud-related features may include, for example, at least one of a feature relating to an installation time of content, a feature relating to a login time for the content, a feature relating to a ratio of users who charge a fee within a set time after an installation of the content, a feature relating to a ratio between a total amount charged for the content and the number of logged in users, a feature relating to a ratio between the total amount charged for the content and the number of users who charge a fee, a feature relating to a ratio of users logged in next day after the installation of the content, or a feature relating to a ratio of users opening the content after the installation of the content.

The processor 605 may extract, from the user data, a correlation coefficient of the installation time of the content (or a content installation time-related correlation coefficient) between users as the feature relating to the installation time of the content (or a content installation time-related feature). To extract the content installation time-related correlation coefficient, the processor 605 may perform grouping on the user data based on an installation date and time of the content. The processor 605 may generate time series data on the number of installations of the content per date and time based on user data grouped based on the installation date and time of the content. The processor 605 may extract a periodic vector for each group of the grouped user data by performing time series decomposition on the time series data. The processor 605 may generate time series data on the number of installations per date and time from user data of a valid group that is a group of users who are not the fraudulent advertising users, and extract a valid periodic vector from the generated time series data. The user data of the valid group may be data previously stored in the processor 605. The processor 605 may calculate a correlation coefficient between the periodic vector for each group and the valid periodic vector. The processor 605 may obtain the installation time-related feature by substituting the calculated correlation coefficient with a scalar value.

The processor 605 may extract, from the user data, a correlation coefficient of the login time for the content (or a content login time-related correlation coefficient) between users as the feature relating to the login time for the content (or a content login time-related feature). To extract the login time-related correlation coefficient, the processor 605 may perform grouping on the user data based on a login date and time. The processor 605 may generate time series data on the number of logins per date and time based on user data grouped based on the login date and time. The processor 605 may extract a periodic vector for each group of the grouped user data by performing time series decomposition on the time series data. The processor 605 may generate time series data on the number of logins per date and time from user data of a valid group, and extract a valid periodic vector from the generated time series data. The processor 605 may calculate a correlation coefficient between the periodic vector for each group and the valid periodic vector. The processor 605 may obtain the login time-related feature by substituting the calculated correlation coefficient with a scalar value.

The processor 605 may classify fake users from the fraudulent advertising users by performing clustering on users based on the extracted features. The processor 605 may preprocess the extracted features to perform the clustering on the users. In at least one example embodiment, the preprocessing performed on the extracted features may include normalization and dimensionality reduction.

The processor 605 may normalize the extracted features to evenly adjust the degrees of influence of the extracted features on the clustering. For example, the processor 605 may perform min-max scaling on the extracted features.

The processor 605 may reduce the dimensionality of the normalized features. For example, the processor 605 may reduce the dimensionality of the normalized features by applying techniques such as a PCA, t-SNE, and an autoencoder. To reduce the dimensionality of the normalized features, various techniques may be used.

The processor 605 may perform the clustering on the users, using features with the reduced dimensionality. For example, the processor 605 may perform the clustering on the users by applying, to such reduced features, a technique such as a K-means algorithm, DBSCAN, or HDBSCAN. To perform the clustering on the users, various techniques may be applied to the features.

The processor 605 may classify the fake users based on a result of the clustering.

The processor 605 may search for a fraud score for each of remaining users who are not classified as the fake users among the users by using an IP-based fraud search service (e.g., Scamalytics) server. The processor 605 may search for the fraud score and classify the remaining users into fake users and genuine users.

For example, the processor 605 may determine whether an advertising fraud score of a user is greater than or equal to a set value. In this example, when the advertising fraud score of the user is greater than or equal to the set value, the processor 605 may determine the user to be a fake user. When the advertising fraud score of the user is less than the set value, the processor 605 may determine the user to be a genuine user.

The example embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An apparatus for classifying fraudulent advertising users, comprising:
a processor; and
a memory configured to store instructions to be executed by the processor,
wherein, when the instructions are executed by the processor, the processor is configured to:
receive user data of users who are first determined to be fraudulent advertising users in relation to advertising fraud of an online advertisement;
extract advertising fraud-related features from the user data;
classify fake users from the users through clustering of the users based on the extracted features;
search for a fraud score for each of remaining users who are not classified as the fake users among the users, using an Internet protocol (IP)-based fraud search service server; and
classify the remaining users into the fake users and genuine users based on the fraud score.

2. The apparatus of claim 1, wherein the processor is configured to:
classify, as the fake users, users having the fraud score that is greater than or equal to a set threshold value; and
determine, as the genuine users, users having the fraud score that is less than the set threshold value.

3. The apparatus of claim 1, wherein the processor is configured to:
normalize the extracted features.

4. The apparatus of claim 3, wherein the processor is configured to:
reduce a dimensionality of the normalized features.

5. The apparatus of claim 4, wherein the processor is configured to:
perform clustering on the users based on features with the reduced dimensionality.

6. The apparatus of claim 1, wherein the features comprise:
a feature relating to an installation time of the content that is the target of the online advertisement, a feature relating to a login time for the content, a feature relating to a ratio of users who charge a fee within a set time after an installation of the content, a feature relating to a ratio between a total amount charged for the content and the number of logged in users, a feature relating to a ratio between the total amount charged for the content and the number of users who charge a fee, a feature relating to a ratio of users logged in next day after the installation of the content, and a feature relating to a ratio of users opening the content after the installation of the content.

7. The apparatus of claim 6, wherein the processor is configured to:
perform grouping on the user data of the users based on the installation date and time of the content;
generate time series data on the number of installations of the content per date and time based on grouped user data obtained through the grouping;
extract a periodic vector for each group of the grouped user data by performing time series decomposition on the time series data;
calculate a correlation coefficient between the periodic vector for each group and a valid periodic vector for user data of a valid group that is a group of general users; and
convert the calculated correlation coefficient to a scalar value.

8. The apparatus of claim 6, wherein the processor is configured to:
perform grouping on the user data of the users based on the login date and time of the content;
generate time series data on the number of logins per date and time based on grouped user data obtained through the grouping;
extract a periodic vector for each group of the grouped user data by performing time series decomposition on the time series data;
calculate a correlation coefficient between the periodic vector for each group and a valid periodic vector for user data of a valid group that is a group of general users; and
convert the calculated correlation coefficient to a scalar value.

9. A method of classifying fraudulent advertising users, comprising:
receiving user data of users who are first determined to be fraudulent advertising users in relation to advertising fraud of an online advertisement;
extracting advertising fraud-related features from the user data;
classifying fake users from the users through clustering of the users based on the extracted features;
searching for a fraud score for each of remaining users who are not classified as the fake users among the users, using an Internet protocol (IP)-based fraud search service server; and
classifying the remaining users into the fake users and genuine users based on the fraud score.

10. The method of claim 9, wherein the classifying into the fake users and the genuine users comprises:
classifying, as the fake users, users having the fraud score that is greater than or equal to a set threshold value; and
determining, as the genuine users, users having the fraud score that is less than the set threshold value.

11. The method of claim 9, wherein the classifying the fake users from the users comprises:
normalizing the extracted features.

12. The method of claim 11, wherein the classifying the fake users from the users further comprises:
reducing a dimensionality of the normalized features.

13. The method of claim 12, wherein the classifying the fake users from the users further comprises:
performing clustering on the users based on features with the reduced dimensionality.

14. The method of claim 9, wherein the features comprise:
a feature relating to an installation time of the content that is the target of the online advertisement, a feature relating to a login time for the content, a feature relating to a ratio of users who charge a fee within a set time after an installation of the content, a feature relating to a ratio between a total amount charged for the content and the number of logged in users, a feature relating to a ratio between the total amount charged for the content and the number of users who charge a fee, a feature relating to a ratio of users logged in next day after the installation of the content, and a feature relating to a ratio of users opening the content after the installation of the content.

15. The method of claim 14, wherein the extracting the features comprises:
performing grouping on the user data of the users based on the installation date and time of the content;
generating time series data on the number of installations of the content per date and time based on grouped user data obtained through the grouping;
extracting a periodic vector for each group of the grouped user data by performing time series decomposition on the time series data;
calculating a correlation coefficient between the periodic vector for each group and a valid periodic vector for user data of a valid group that is a group of general users; and
converting the calculated correlation coefficient to a scalar value.

16. The method of claim 14, wherein the extracting the features comprises:
performing grouping on the user data of the users based on the login date and time of the content;
generating time series data on the number of logins per date and time based on grouped user data obtained through the grouping;
extracting a periodic vector for each group of the grouped user data by performing time series decomposition on the time series data;
calculating a correlation coefficient between the periodic vector for each group and a valid periodic vector for user data of a valid group that is a group of general users; and
converting the calculated correlation coefficient to a scalar value.

17. A non-transitory computer-readable storage medium storing instructions that, when executed by a processor, cause the processor to perform the method of claim 9.
